(19) United States
(12) Patent Application Publication
(10) Pub. No.: US 2026/0140948 A1
(43) Pub. Date: May 21, 2026

(54) ANALYTICS ENGINE AUTOTUNING

(71) Applicant: Google LLC, Mountain View, CA (US)

(72) Inventors: Isha Tarte, San Jose, CA (US); Andrew Jason Ma, Kirkland, WA (US); David Rabinowitz, Sunnyvale, CA (US); Wei Yan, Los Altos, CA (US); Mikita Trush, Woodinville, WA (US); Zhongwei Zhu, Bellevue, WA (US); Abhishek Modi, Bengaluru (IN); Bhooshan Deepak Mogal, Foster City, CA (US); Igor Dvorzhak, San Jose, CA (US); Chia-Jung Hsu, Seattle, WA (US)

(73) Assignee: Google LLC, Mountain View, CA (US)

(21) Appl. No.: 18/952,943

(22) Filed: Nov. 19, 2024

(51) Int. Cl. G06F 16/2453; G06F 16/21; G06F 16/2455

(52) U.S. Cl. CPC G06F 16/24544; G06F 16/217; G06F 16/2456

(57) ABSTRACT

A method includes receiving, from a user, a request to execute a cohort of workloads by an analytics engine at a distributed computing system. The cohort defines a serial execution order for executing each of the workloads in the cohort. Based on the serial execution order, the method includes executing, using the analytics engine and a default join configuration, a first portion of the workloads in the cohort. The method includes determining, based on execution of the first portion of the workloads in the cohort, an updated join configuration. Based on the serial execution order, the method includes executing, using the analytics engine and the updated join configuration, a second portion of the workloads in the cohort. The method also includes returning, to the user, results of execution of the first portion and the second portion of the workloads in the cohort.

### TECHNICAL FIELD

This disclosure relates to autotuning an analytics engine, such as Apache Spark.

### BACKGROUND

Distributed computing systems utilize multiple computing devices or nodes to perform tasks or provide services, offering benefits like scalability, fault tolerance, parallelism, and resource utilization. However, they also present challenges such as coordination, communication, synchronization, and load balancing. A specific type of distributed computing system is a cluster computing system, which consists of interconnected nodes working together on a common task. These systems are used in applications like data processing, analysis, mining, machine learning, and artificial intelligence (AI). Apache Spark is an example of a cluster computing system that provides an analytics engine for large-scale data processing. It handles various workloads, such as batch processing, streaming, interactive queries, and machine learning, using a directed acyclic graph (DAG) of tasks. Apache Spark and other analytics engines optimize workload execution through techniques like lazy evaluation, caching, query optimization, and adaptive query execution. These analytics engines typically offer a diverse set of configuration options that can have significant impact on the performance of workload execution.

### SUMMARY

One aspect of the disclosure provides a method for executing a cohort of workloads. The method, when executed by data processing hardware, causes the data processing hardware to perform operations. The operations include receiving, from a user, a request to execute a cohort of workloads by an analytics engine at a distributed computing system. The cohort defines a serial execution order for executing each of the workloads in the cohort. Based on the serial execution order, the operations include executing, using the analytics engine and a default join configuration, a first portion of the workloads in the cohort. The default join configuration defines a first join operation to use during execution of the first portion of the workloads. The operations include determining, based on execution of the first portion of the workloads in the cohort, an updated join configuration. The operations also include, based on the serial execution order, executing, using the analytics engine and the updated join configuration, a second portion of the workloads in the cohort. The updated join configuration defines a second join operation to use during execution of the second portion of the workloads. The second join operation is different from the first join operation. The operations also include returning, to the user, results of execution of the first portion and the second portion of the workloads in the cohort.

Implementations of the disclosure may include one or more of the following optional features. In some implementations, the updated join configuration includes a broadcast hash join. The default join configuration may include one of a sort merge join, a shuffle hash join, a Cartesian join, or a broadcasted nested loop join, Optionally, executing, using the analytics engine and the updated join configuration, the second portion of the workloads in the cohort includes providing, to the analytics engine, a query hint associated with the updated join configuration.

In some examples, determining the updated join configuration includes determining one or more successful broadcasts of data in execution of the first portion of the workloads in the cohort. Using the updated join configuration may reduce an execution time of the second portion of the workloads in the cohort relative to using the default join configuration.

In some implementations, the operations further include determining, based on execution of the first portion of the workloads in the cohort, an updated executor memory configuration. In these implementations, executing the second portion of the workloads in the cohort includes using the updated executor memory configuration. The updated executor memory configuration defines an amount of memory available to execute the second portion of the workloads. In some of these implementations, the amount of memory defined by the updated executor memory configuration is greater than an amount of memory available when executing the first portion of the workloads or the amount of memory defined by the updated executor memory configuration is less than an amount of memory available when executing the first portion of the workloads.

In some examples, the operations further include determining, based on execution of the first portion of the workloads in the cohort, an updated initial number of executors and an updated maximum number of executors. In these examples, executing the second portion of the workloads in the cohort includes using the updated initial number of executors and the updated maximum number of executors. The updated initial number of executors defines a number of executors to use when beginning execution of the second portion of the workloads, and the updated maximum number of executors defines a maximum number of executors to use when executing the second portion of the workloads.

Another aspect of the disclosure provides a system for executing a cohort of workloads. The system includes data processing hardware and memory hardware in communication with the data processing hardware. The memory hardware stores instructions that when executed on the data processing hardware cause the data processing hardware to perform operations. The operations include receiving, from a user, a request to execute a cohort of workloads by an analytics engine at a distributed computing system. The cohort defines a serial execution order for executing each of the workloads in the cohort. Based on the serial execution order, the operations include executing, using the analytics engine and a default join configuration, a first portion of the workloads in the cohort. The default join configuration defines a first join operation to use during execution of the first portion of the workloads. The operations include determining, based on execution of the first portion of the workloads in the cohort, an updated join configuration. The operations also include, based on the serial execution order, executing, using the analytics engine and the updated join configuration, a second portion of the workloads in the cohort. The updated join configuration defines a second join operation to use during execution of the second portion of the workloads. The second join operation is different from the first join operation. The operations also include returning, to the user, results of execution of the first portion and the second portion of the workloads in the cohort.

This aspect may include one or more of the following optional features. In some implementations, the updated join configuration includes a broadcast hash join. The default join configuration may include one of a sort merge join, a shuffle hash join, a Cartesian join, or a broadcasted nested loop join. Optionally, executing, using the analytics engine and the updated join configuration, the second portion of the workloads in the cohort includes providing, to the analytics engine, a query hint associated with the updated join configuration.

In some examples, determining the updated join configuration includes determining one or more successful broadcasts of data in execution of the first portion of the workloads in the cohort. Using the updated join configuration may reduce an execution time of the second portion of the workloads in the cohort relative to using the default join configuration.

In some implementations, the operations further include determining, based on execution of the first portion of the workloads in the cohort, an updated executor memory configuration. In these implementations, executing the second portion of the workloads in the cohort includes using the updated executor memory configuration. The updated executor memory configuration defines an amount of memory available to execute the second portion of the workloads. In some of these implementations, the amount of memory defined by the updated executor memory configuration is greater than an amount of memory available when executing the first portion of the workloads or the amount of memory defined by the updated executor memory configuration is less than an amount of memory available when executing the first portion of the workloads.

In some examples, the operations further include determining, based on execution of the first portion of the workloads in the cohort, an updated initial number of executors and an updated maximum number of executors. In these examples, executing the second portion of the workloads in the cohort includes using the updated initial number of executors and the updated maximum number of executors. The updated initial number of executors defines a number of executors to use when beginning execution of the second portion of the workloads, and the updated maximum number of executors defines a maximum number of executors to use when executing the second portion of the workloads.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1 is a schematic view of an example distributed computing system for executing a cohort of workloads using an analytics engine.

FIG. 2 is a schematic view of exemplary components of the distributed computing system of FIG. 1.

FIGS. 3A and 3B are schematic views of interactions between an analytics engine and an autotuning controller.

FIG. 4 is a flowchart of an example arrangement of operations for a method of executing a cohort of workloads using an analytics engine.

FIG. 5 is a schematic view of an example computing device that may be used to implement the systems and methods described herein.

Like reference symbols in the various drawings indicate like elements.

### DETAILED DESCRIPTION

Distributed computing systems are systems that use multiple computing devices or nodes to perform tasks or provide services. Distributed computing systems can offer advantages such as scalability, fault tolerance, parallelism, and resource utilization. However, distributed computing systems also pose challenges such as coordination, communication, synchronization, and load balancing among the nodes.

Distributed systems utilize the computational power of multiple nodes which work together to perform a common task or function. There are multiple sophisticated software tools available which can be used for various applications, such as data processing, data analysis, data mining, machine learning, and artificial intelligence.

One example of such a software tool is Apache Spark, which is an open-source framework and analytics engine for large-scale data processing. Apache Spark runs on a cluster of nodes and executes various types of workloads, such as batch processing, streaming processing, interactive queries, and machine learning. A workload in Apache Spark is a unit of computation that can be expressed as a directed acyclic graph (DAG) of tasks. A task is a unit of execution that performs a specific operation on a partition of data. A partition is a logical chunk of data that can be stored and processed on a single node. A DAG is a graph that represents the dependencies and order of execution of tasks. A workload can be submitted to Apache Spark by a user or an application through an application programming interface (API) or a command-line interface (CLI).

Analytics engines like Apache Spark use various techniques and algorithms to optimize the execution of workloads on a cluster of nodes. For example, Apache Spark uses lazy evaluation, which means that it delays the execution of tasks until the results are needed or requested by the user or the application. Apache Spark may also use caching, which stores intermediate results of tasks in memory or disk for faster access and reuse. Analytics engines may also make use of query optimization, which includes analyzing and transforming the logical plan of a workload into a physical plan that minimizes the cost of execution. Another technique is adaptive query execution, which causes dynamically adjustment of the physical plan of a workload based on runtime statistics and feedback.

Enhancing the performance and resiliency of workloads for such analytics engines presents significant challenges due to the extensive array of configuration options and the complexity involved in evaluating the impact of these options on the workload. Additionally, the tuning of workloads is not a static process; it requires continuous adjustments as the underlying data, query characteristics, and engine evolve over time. Autotuning offers a solution to manual workload configuration by automatically applying configuration settings to recurring workloads. This process is based on optimization best practices and an analysis of previous workload executions.

One of the techniques and algorithms that analytics engines such as Apache Spark use to optimize the execution of workloads is join optimization. A join is an operation that combines two or more datasets based on a common attribute or condition. A join can be performed in various ways, such as sort merge join, shuffle hash join, broadcast hash join, Cartesian join, and broadcasted nested loop join. Each join method has different advantages and disadvantages based on the joined datasets in terms of performance, scalability, memory usage, and network traffic.

Analytics engines typically use a default join configuration to determine which join method to use for each join operation in a workload. The default join configuration may be based on various factors, such as the size of the datasets, the availability of statistics, the presence of hints, and configuration parameters. However, the default join configuration may not always be optimal for the execution of workloads, as it may not account for the dynamic and heterogeneous nature of the cluster computing system and the data sources. For example, the default join configuration may not consider sizes of the data, changes in the data distribution, the data skewness, the data locality, the node availability, the node capacity, the node load, and/or the network congestion that may occur during the execution of workloads.

Analytics engines commonly provide many different configuration options, such as the join configurations, memory configurations, etc. Each of these configurations may impact the performance of workload execution, however it is difficult for users to determine which configuration options are best for a particular job. Therefore, there is a need for methods and systems that can improve the execution of workloads (i.e., by reducing the amount of time workloads take to execute and/or reduce the amount of computing resources necessary to execute the workload and/or increasing the resiliency of the runs of the workload) by automatically determining and updating configuration options for an analytics engine (e.g., join configurations) based on runtime information and feedback.

Implementations herein provide methods and systems for executing a cohort of workloads using an analytics engine in a distributed computing system. A cohort of workloads may refer to a group of workloads that are executed in a serial order by the cluster computing system.

The implementations include receiving, from a user, a request to execute a cohort of workloads by an analytics engine at a distributed computing system. The cohort defines a serial execution order for executing each of the workloads in the cohort. Each workload may be independent of each other workload. That is, there may be no relation between the workloads other than being assigned to the same workload (e.g., based on a code or identifier or the like) and/or working data of similar size or types. Put another way, a cohort is a means to specify or identify multiple workloads as similar workloads, such as an hourly event processing task. While there may be no relation between the first such task (e.g., a 2 PM task) and the subsequent such task (e.g., the 3 PM task), they may be in the same cohort based on a code and/or based on the data each task operates on. Based on the serial execution order, the implementations may include executing, using the analytics engine and a default join configuration, a first portion of the workloads in the cohort. The implementations may include determining, based on execution of the first portion (e.g., a first run or first execution) of the workloads in the cohort, an updated join configuration and, based on the serial execution order, executing, using the analytics engine and the updated join configuration, a second portion of the workloads in the cohort.

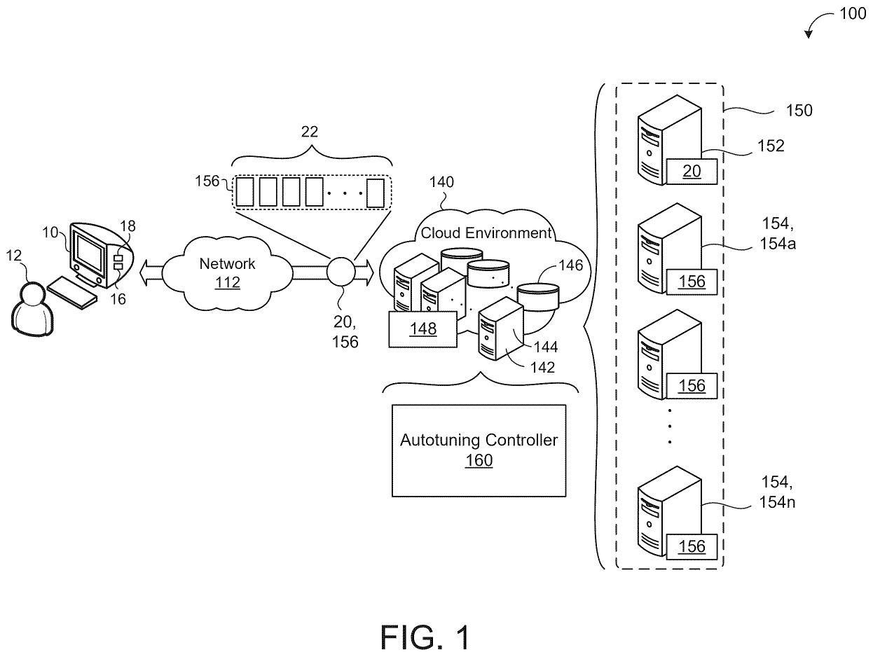

FIG. 1 is a schematic view of an example distributed computing system 100 for executing a cohort of workloads using an analytics engine. The system 100 includes a remote distributed computing system 140 that includes a cluster of nodes 150 interconnected by a network. The nodes 150 may include any computing devices, such as servers, workstations, laptops, or mobile devices, that have data processing hardware and memory hardware. The network can be any communication network, such as a local area network (LAN), a wide area network (WAN), a wireless network, or the Internet, that enables data transmission and communication among the nodes 150.

The remote system 140 is in communication with one or more user devices 10 via a network 112. The user device 10 may correspond to any computing device, such as a desktop workstation, a laptop workstation, or a mobile device (i.e., a smart phone). The user device 10 includes computing resources 18 (e.g., data processing hardware) and/or storage resources 16 (e.g., memory hardware).

The distributed computing system 100 also includes one or more data sources 106 that store and provide data to the nodes 150. The data sources 106 can be any storage devices or systems, such as databases, data warehouses, data lakes, data streams, files, or cloud storage services, that store and provide structured, semi-structured, or unstructured data. The data sources 106 can be located on the same network as the nodes 150 (or the network 112) or on a different network that is accessible by the nodes 150.

The distributed computing system 100 further includes an analytics engine 148 that runs on the cluster of nodes 150 and executes various types of workloads 156 (also referred to as jobs) on the data provided by the data sources 106. The analytics engine 148 can be any software framework or platform that enables large-scale data processing, data analysis, data mining, machine learning, or artificial intelligence on a distributed computing system. For example, the analytics engine 148 can be Apache Spark, which is an open-source framework for large-scale data processing. The analytics engine 148 can support various programming languages and various data sources.

The analytics engine 148 includes a driver 152 and one or more executors 154, 154a-n. The driver 152 is a process or module that executes on one of the nodes 150 and coordinates the execution of workloads 156 on the cluster of nodes 150. The driver 152 receives requests 20 to execute workloads 156 from users or applications and converts the requests 20 into logical plans that represent the workloads 156 as, for example, directed acyclic graphs (DAGs) of tasks. The driver 152 may also optimize the logical plans into physical plans that specify how to execute the tasks on the cluster of nodes 150. The driver 152, in some examples, assigns the tasks to the executors 154 and monitors the progress and status of the execution.

The executors 154 are processes or modules that run on one or more nodes 150 and execute the tasks assigned by the driver 152. The executors 154 read data from the data sources 106, perform computations on the data, write intermediate or final results to memory or disk, and communicate with the driver 152 and other executors 154. The executors 154 can run in parallel on different nodes 150 to achieve scalability and parallelism.

A workload 156 in the analytics engine 148 is a unit of computation that can be expressed as a DAG of tasks. A task is a unit of execution that performs a specific operation on a partition of data. A partition is a logical chunk of data that can be stored and processed on a single node 150. A DAG is a graph that represents the dependencies and order of execution of tasks. A workload 156 can be submitted to the analytics engine 148 by a user or an application through an application programming interface (API) or a command-line interface (CLI).

A cohort of workloads 156 is a group of workloads 156 that are executed in a serial order 22 by the analytics engine 148. A cohort of workloads 156 can be defined by a user or an application to perform a complex or composite analysis or computation on a large or diverse dataset. For example, a cohort of workloads 156 can be used to perform data cleansing, data transformation, data processing, data aggregation, data visualization, and data modeling on a dataset. Generally, the cohort of workloads 156 refers to workloads 156 that are related, such as recurring batch workloads 156. Each workload 156 in the cohort may have similar characteristics, such as the intent of the workload 156 (i.e., the problem the workload 156 is trying to solve, typically represented by the overall query plan without expressions), the data (i.e., the dataset, configuration variables, etc. that define how the intent is executed), and the environment (i.e., the condition in which the intent runs, including the hardware that is used).

The cohort of workloads 156 may be identified by a user (i.e., the user may identify or group the workloads 156 into the cohort). For example, the user assigns an identifier or the like to each workload 156 in a cohort. In other examples, the system determines the workloads 156 in the cohort based on similarities in the workloads 156 (e.g., the data tables the workloads 156 access, the type of executions the workloads 156 include, etc.). For example, the system may use machine learning or another algorithm to group/cluster the workloads 156 into cohorts based on characteristics of the workloads 156. In other examples, the system determines the workloads 156 in a cohort (e.g., determines a cohort identifier for each workload 156) using the properties of the job script such as date last modified, file signature, name etc. and/or the input data and the parameter specified by the user while submitting the application such as arguments, properties etc. When the application or workload 156 is submitted using a workflow management platform such as Apache Airflow, the cohort identifier of the workload 156 may be generated based on the task name grouping the workloads 156 with the same task name in the same cohort.

The analytics engine 148 uses various techniques and algorithms to optimize the execution of workloads 156 and cohorts of workloads 156 on the cluster of nodes 150. For example, the analytics engine 148 uses lazy evaluation, caching, query optimization, and/or adaptive query execution.

In some implementations, the analytics engine 148 uses join optimization to optimize execution of workloads 156 and cohorts of workloads 156. A join is an operation that combines two or more datasets based on a common attribute or condition. The analytics engine 148 may implement a variety of join techniques, such as sort merge join, shuffle hash join, broadcast hash join, Cartesian join, broadcasted nested loop join, and broadcast hash join. Each join method has different advantages and disadvantages in terms of performance, scalability, memory usage, and network traffic. For example, one join technique may be better (e.g., more efficient, faster, etc.) in joining large tables while a different join technique may be better in joining small tables. For example, a sort merge is most useful (i.e., offers the best performance and/or efficiency) when joining two large datasets that cannot fit into memory and/or joining datasets that are already sorted on the join keys. In contrast, a broadcast hash join is most useful when one dataset is significantly smaller than the other and the smaller dataset can fit entirely in memory.

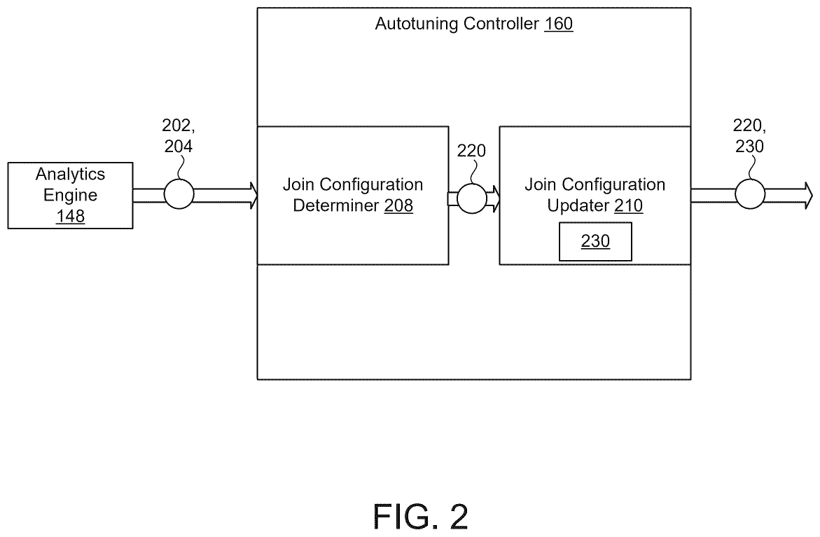

The analytics engine 148 uses a default join configuration 202 (FIG. 2) to determine which join method to use for each join operation in a workload 156. The default join configuration 202 may be predetermined or be based on various factors. Notably, the default join configuration 202 is not always optimal for the execution of each workload 156 in the cohort.

Accordingly, implementations herein include an autotuning controller 160 that can improve the execution of workloads 156 within a cohort by automatically (i.e., without user intervention) configure one or more options of the analytics engine 148.

The autotuning controller 160, in some examples, operates on the same node as the driver 152. In other examples, the autotuning controller 160 operates on a different node 150 or at the remote system 140. The autotuning controller 160 evaluates the execution of previous workloads 156 in the cohort and, based on the evaluations, the autotuning controller 160 may adjust one or more configuration parameters of the analytics engine 148 before executing current and/or future workloads 156 in the cohort. For example, the autotuning controller 160 determines and updates join configurations 202 based on runtime information and feedback. The autotuning controller 160 receives, from a user, a request 20 to execute a cohort of workloads 156 by the analytics engine 148 at the distributed computing system 100. The cohort defines a serial execution order 22 for executing each of the workloads 156 in the cohort.

Conventionally, when beginning execution of a workload 156, the analytics engine 148 typically has little knowledge of the underlying data sources of the workload 156. For example, the analytics engine 148 may not be aware of a size of a data source a priori. Accordingly, the analytics engine 148 begins execution of the workload 156 using one or more default configuration settings. For example, the analytics engine 148 begins execution of the workload 156 using a sort merge join configuration option, which instructs the analytics engine 148 to use a sort merge join when joining datasets. During execution of the workload 156, the analytics engine 148 determines qualities or parameters about the data sources or datasets (e.g., sizes of the datasets) and may update or adjust one or more configuration options to improve further execution of the workload 156. For example, when the analytics engine 148 determines that a join requires joining a large dataset with a small dataset, the analytics engine 148 may switch to using a broadcast hash join instead of the default sort merge join.

A broadcast hash join is advantageous when one dataset is significantly smaller than the other. Generally, the smaller dataset must fit in memory. A broadcast hash typically involves broadcasting the smaller dataset to all executors in the cluster and then the smaller dataset is hashed across all the executors and then joined with the larger dataset. While this switch will lead to performance improvements for the remainder of the execution of the workload 156 when one dataset is significantly smaller than the other, any performance benefits from using the broadcast hash join from beginning of execution of the workload 156 to the current point in the workload 156 is lost. That is, performance benefit was lost by not beginning execution of the workload 156 using the broadcast hash join.

Based on the serial execution order 22, the autotuning controller 160 executes, using the analytics engine 148 and a default join configuration 202 (e.g., a sort merge join configuration or a shuffle hash join configuration), a first portion of the workloads 156 in the cohort. The default join configuration 202 defines a particular join operation to use during execution of the first portion of the workloads 156. During and/or after execution of the first portion of the workloads 156, the autotuning controller 160 collects or determines data related to execution of the workloads 156. This data may include performance data 204 from the analytics engine (i.e., any data generated by the analytics engine 148 during execution of the workloads 156) or other data obtained by the autotuning controller 160 from other systems or from observing/querying the data sources directly. For example, the autotuning controller 160 determines information regarding which tables are broadcastable, changes in the initial and/or final plan of the job execution, reduction factor of aggregators to avoid local aggregations, hints to generate bloom filters, identification of fact versus dimension tables, identification of opportunities for materialized views with quantifiable gains, etc.

The autotuning controller 160 determines, based on execution of the first portion of the workloads 156 in the cohort, an updated join configuration 220 (e.g., a broadcast hash join configuration). For example, after the analytics engine 148 bas executed one or more workloads 156 in the cohort (i.e., the first portion), the autotuning controller 160 determines that the analytics engine 148, during execution of the one or more workloads 156, switched from using the default join configuration 202 to the updated join configuration 220.

Based on the serial execution order 22, the autotuning controller 160 executes, using the analytics engine 148 and the updated join configuration 220, a second portion (e.g., a further run or further execution) of the workloads 156 in the cohort (e.g., the workloads 156 in the cohort not previously executed). The updated join configuration 220 defines a second join operation to use during execution of the second portion of the workloads 156. The second join operation may be different from the first join operation. For example, the first join operation is a sort merge join operation and the second join operation is a broadcast hash join operation. Using the updated join configuration 220 improves performance (e.g., by reducing an execution time or a resource usage) of the second portion of the workloads 156 in the cohort relative to using the default join configuration 202. The autotuning controller 160 may return, to the user, results of execution of the first portion and the second portion of the workloads 156 in the cohort.

Referring now to FIG. 2, in some implementations, the autotuning controller 160 includes a join configuration determiner 208 and a join configuration updater 210. The join configuration determiner 208 determines an updated join configuration 220 based on execution of a first portion of the workloads 156 in the cohort (i.e., execution of one or more workloads 156). The first portion of the workloads 156 refers to one or more workloads 156 of the cohort executed based on the serial execution order 22. The join configuration determiner 208 monitors and analyzes the execution of the first portion of the workloads 156 in the cohort using the default join configuration 202 and performance data 204, and the join configuration determiner 208 may collect and evaluate various runtime information and feedback, such as the size of the datasets, the data distribution, the data skewness, the data locality, the node availability, the node capacity, the node load, the network congestion, the join method, the join performance, the join cost, and/or the join result.

Based on the runtime information and feedback, the join configuration determiner 208 determines an updated join configuration 220 that defines a second join operation to use during execution of a second portion of the workloads 156 in the cohort (i.e., one or more workloads 156 in the cohort not already executed). In some examples, the join configuration determiner 208 uses machine learning trained on a dataset of cohorts and respective workloads 156. The machine learning model may process the previous workloads 156 and/or the upcoming workloads 156 in the cohort to determine optimal configuration options for each respective workload 156.

The second join operation may be different from the first join operation defined by the default join configuration 202. For example, the join configuration determiner 208 may determine that a broadcast hash join is more suitable than a sort merge join for executing the second portion of the workloads 156 in the cohort, based on the runtime information and feedback. In some examples, the autotuning controller 160 determines the updated join configuration 220 based on determining one or more successful broadcasts of data in execution of the first portion of the workloads 156 in the cohort (which may signal successful use of broadcast hash joins during execution of the first portion of the workloads 156). The autotuning controller 160 may analyze the query plans of the workloads 156 of the first portion (e.g., to determine broadcasts). Optionally, the autotuning controller 160 determines when the analytics engine 148 starts a shuffle and converts the shuffle to a broadcast.

The join configuration updater 210 may update a current join configuration 230 based on the updated join configuration 220 determined by the join configuration determiner 208. The current join configuration 230 may be initially set to the default join configuration 202 and then adjusted to reflect the updated join configuration 220. In some examples, the join configuration determiner 208 may periodically or continuously determine the updated join configuration 220 and the current join configuration may be adjusted from a previous updated join configuration 220 to a newer updated join configuration 220. That is, in some implementations, as workloads are executed by the analytics engine 148 (i.e., a first portion, a second portion, a third portion, etc.), the join configuration determiner 208 may continue to update the updated join configuration 220 and the join configuration updater 210 may track the latest or most recent updated join configuration via the current join configuration 230. For example, the join configuration determiner 208 further refines or improves the updated join configuration based on the execution of additional workloads 156 (which may be at least partially executed using the default join configuration 202 and/or an updated join configuration 220).

The join configuration updater 210, in some implementations, modifies the execution plan generated by the analytics engine 148 of the second portion of the workloads 156 in the cohort to use the second join operation defined by the updated join configuration 220. In some implementations, the join configuration updater 210 provides a query hint associated with the current join configuration 230 to the analytics engine 148. The query hint is a directive or suggestion that instructs or influences the analytics engine 148 to use a specific join method or parameter for executing the second portion of the workloads 156 in the cohort. For example, the join configuration updater 210 may provide a query hint that indicates that a broadcast hash join should be used for executing the second portion of the workloads 156 in the cohort.

The autotuning controller 160 executes the second portion of the workloads 156 in the cohort using the analytics engine 148 and the current join configuration 230. In some examples, the second portion of the workloads 156 is all of the remaining workloads 156 in the cohort (i.e., all of the workloads 156 that are not in the first portion). In other examples, the second portion is not all of the remaining workloads 156, and the autotuning controller 160, after execution of the workloads 156 in the second portion, may make additional configuration adjustments and then continue execution of a third portion of the workloads 156 in the cohort, and so on and so forth. The autotuning controller 160 returns the results of execution of the first portion and the second portion (and other portions) of the workloads 156 in the cohort to the user or the application.

The autotuning controller 160 may also determine and update other configurations that affect the execution of workloads 156 and cohorts of workloads 156, such as driver/executor memory configurations, initial executor amounts or numbers, and maximum executor amounts or numbers. The driver and executor memory configuration define an amount of memory available to the driver and to the executor to execute a portion of the workloads 156 in the cohort respectively.

The initial executor amount defines a number of executors to use to begin executing the workloads 156 in the cohort. In contrast, the maximum executor amount defines a maximum number of executors the analytics engine 148 may use while executing the workloads 156. Put another way, the initial executor amount defines how many executors the analytics engine 148 begins with and the maximum executor amount defines how many executors the analytics engine 148 can scale to. The autotuning controller 160 may determine and update these configurations based on runtime information and feedback (i.e., from execution of previous workloads 156 in the cohort, such as execution of the first portion of workloads 156) and optimize the resource utilization and allocation for executing workloads 156 and cohorts of workloads 156.

For example, the autotuning controller 160 determines whether there are any out-of-memory (OOM) errors or failures during the execution of the workloads 156 in the first portion. In this example, the autotuning controller 160 may increase the amount of memory available for the second portion of the workloads 156. In another example, the autotuning controller 160 determines that workloads 156 in the first portion use less than a threshold percentage of the available memory. In this example, the autotuning controller 160 reduces the amount of memory available for the second portion of the workloads 156 (which may reduce costs and/or free resources for other workloads 156). Similarly, the autotuning controller 160 may increase or decrease the initial executor amount and maximum executor amount based on the execution of previous workloads 156 in the cohort. For example, execution of a workload 156 may start slowly when the initial executor amount is set too low. By increasing the initial executor amount, the autotuning controller 160 may prevent slow startup issues while also reducing costs associated with executing the workload 156.

While specific configuration options have been used as examples herein (e.g., join configuration, memory configurations, executor amount configurations, etc.), any configuration options offered by analytic engines may be automatically tuned by the autotuning controller 160 based on feedback from execution of previous workloads 156 in the cohort (i.e., the group of workloads 156 confirmed to be related and/or similar). For example, the autotuning controller 160 may optimize partitioning configuration, clustering configuration, autoscaling configuration (e.g., min, max, cool down periods), hardware selection/configuration, etc.

In some implementations, the autotuning controller 160 tunes the resources allocated to the cluster based on the actual usage and performance of the cluster. For example, when the autotuning controller 160 determines that the cluster was over-provisioned and not all of the resources were used, the autotuning controller 160 creates a following cluster with a smaller amount of resources, such as a lower number of executors, a lower number of CPUs, less memory, or a combination thereof, hence reducing the cost of the execution. Alternatively or additionally, if the autotuning controller 160 determines that the cluster was under-provisioned and the resources were insufficient to meet the performance or reliability requirements, the autotuning controller 160 may create a following cluster with a larger amount of resources, such as a higher number of executors, a higher number of CPUs, more memory, or a combination thereof, hence improving the performance or reliability of the execution.

In some implementations, the autotuning controller 160 can also optimize the serialization and deserialization of data in the cluster. For example, if the autotuning controller 160 detects or determines that the cluster is using Spark's Java serializer, which can be inefficient and slow for some types of data, the autotuning controller 160 tracks the serialized classes and register a more efficient kryo serializer with the used classes. For example, the autotuning controller 160 can configure one or more properties to prevent the serialization of unregistered classes and avoid performance degradation. Alternatively or additionally, when the autotuning controller 160 determines that the cluster is using kryo serializer, but some of the classes are not registered or are registered incorrectly, the autotuning controller 160 tracks the serialization errors and registers the correct classes with the kryo serializer.

In some examples, the autotuning controller 160 adjusts the hardware configuration of the cluster based on the characteristics and requirements of the workload. For example, if the autotuning controller 160 determines that the cluster is using CPU-intensive or memory-intensive operations, such as machine learning or graph processing, the autotuning controller 160 configures the following execution to use stronger CPUs or more memory, respectively, which can improve the performance or reduce the cost of the execution. Alternatively or additionally, when the autotuning controller 160 detects that the cluster is using disk-intensive or network-intensive operations, such as sorting or shuffling, the autotuning controller 160 can configure the following execution to use larger or faster disks or network bandwidth, respectively, which can improve the performance or reduce the cost of the execution. In some cases, the autotuning controller 160 configures the following execution to use GPUs and the relevant libraries, such as TensorFlow or PyTorch, if the workload involves artificial intelligence or deep learning operations, which can significantly improve the performance or reduce the cost of the execution.

In some implementations, the autotuning controller 160 selects an alternative query engine for the cluster based on the type and complexity of the queries. For example, when the autotuning controller 160 determines that the cluster is using Spark SQL, which can be inefficient or incompatible for some types of queries, such as nested or recursive queries, the autotuning controller 160 configures the following execution to use Spark's native query engine, which can support more query features and optimize the query execution plan. Alternatively or additionally, when the autotuning controller 160 detects that the cluster is using Spark's native query engine, but some of the queries are simple or standard, such as SQL-92 compliant queries, the autotuning controller 160 can configure the following execution to use Spark SQL, which can leverage the existing SQL engines and libraries and improve the compatibility and portability of the queries.

In some examples, the autotuning controller 160 tunes the garbage collection settings of the cluster based on the memory usage and performance of the cluster. For example, when the autotuning controller 160 detects that the cluster is using the default garbage collector, which can cause long pauses or high overhead for some workloads, the autotuning controller 160 tracks the Java Virtual Machine garbage collection log and configure the following execution to use a different garbage collector, such as GI or ZGC, which can reduce the pause time or the memory footprint. Alternatively or additionally, when the autotuning controller 160 detects that the cluster is using a specific garbage collector, but some of the parameters are not optimal, such as the heap size, the young generation size, or the survivor ratio, the autotuning controller 160 tracks the Java Virtual Machine garbage collection log and configure the following execution to adjust the parameters to better suit the workload.

Optionally, the autotuning controller 160 detects and handles skewed partitions in the cluster based on the task metrics or error logs. For example, when the autotuning controller 160 detects that some of the partitions are much larger or smaller than others, which can cause load imbalance or resource wastage, the autotuning controller 160 can adapt the spark sql.adaptive.skewJoin.skewedPartition-ThresholdInBytes and spark sql shuffle partitions properties to better values, which can split the skewed partitions into smaller ones or coalesce the small partitions into larger ones, respectively. The autotuning controller 160 may modify the memory settings of the cluster, such as the spark.executor memory or spark.memory.fraction properties, to avoid out-of-memory errors or improve the memory utilization.

In some implementations, the autotuning controller 160 leverages the cross-batch information to improve the configuration of the cluster. For example, the autotuning controller 160 accesses the metrics and configurations of all the batches of all the customers that are executed by the autotuning controller 160 and use this information to learn which configurations are working better than others for similar workloads. The autotuning controller 160 may cluster the batches based on the number and size of the inputs, as taken from the jobs metrics, and check which configurations lead to better performance and cost. The autotuning controller 160 can then apply the best configurations to the following executions of the batches that belong to the same cluster or a similar cluster.

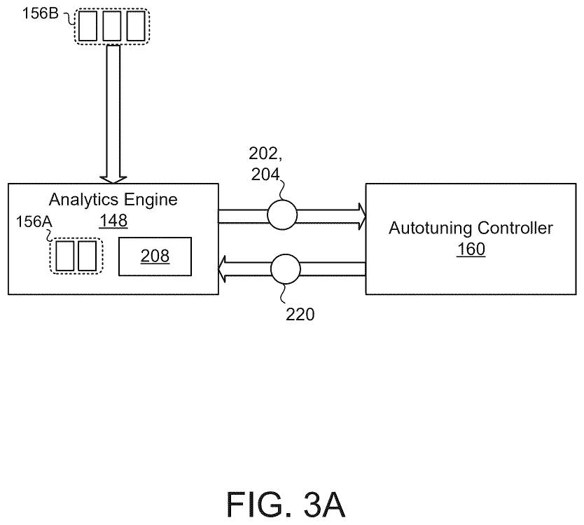

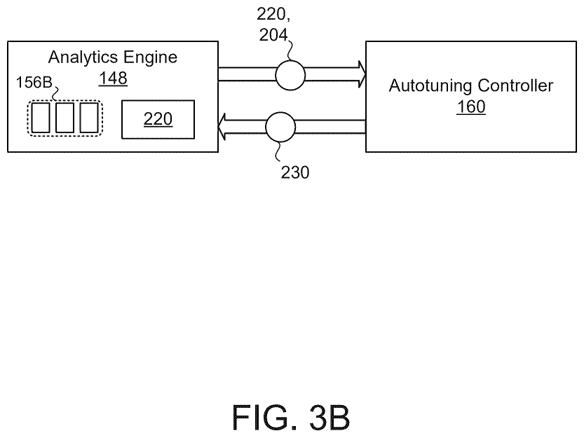

FIGS. 3A and 3B provide an exemplary illustration of the interactions between the analytics engine 148 and the autotuning controller 160. Here, the analytics engine 148 has received a request to execute a cohort of five workloads 156. In FIG. 3A, the analytics engine 148 begins by executing a first portion of the workloads 156A (i.e., two of the five workloads 156) using a default join configuration 202. Based on the default join configuration 202, the workloads 156, and/or performance data 204, the autotuning controller 160 determines an updated join configuration 220 and provides the updated join configuration 220 to the analytics engine 148 (e.g., via a query hint). As shown in FIG. 3B, the analytics engine 148 executes a second portion of the workloads 156B (i.e., the three remaining workloads 156) using the updated join configuration 220. This allows the analytics engine 148 to execute the workloads 156 faster and/or using less resources. The autotuning controller 160 may provide any number of updated join configurations 220 (i.e., current join configurations 230) based on additional performance data 204 or other information.

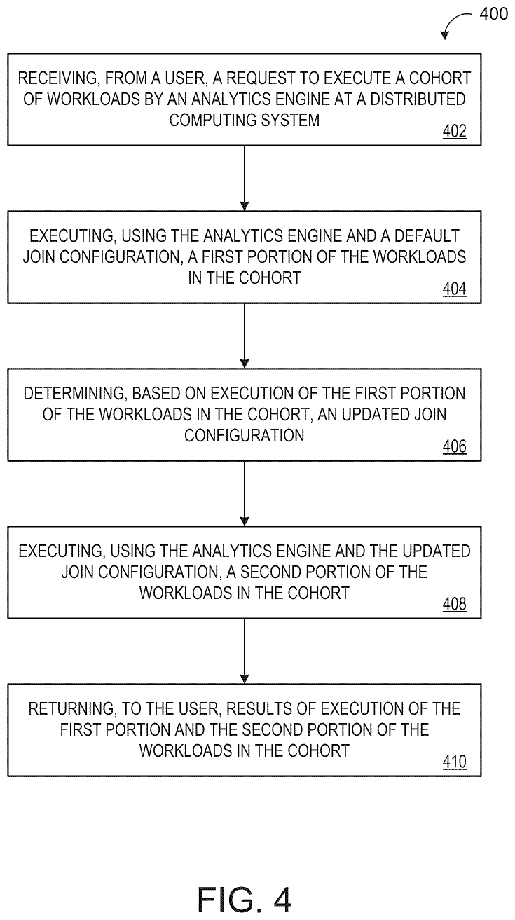

FIG. 4 is a flowchart of an exemplary arrangement of operations for a method 400 of executing a cohort of workloads 156 using an analytics engine in a distributed computing system.

The computer-implemented method 400, when executed by data processing hardware, causes the data processing hardware to perform operations. The method 400, at operation 402, includes receiving, from a user, a request 20 to execute a cohort of workloads 156 by an analytics engine at a distributed computing system. The cohort defines a serial execution order 22 for executing each of the workloads 156 in the cohort. The user may be a human user or an application that submits the request 20 to execute the cohort of workloads 156. The request 20 may be submitted, for example, through an application programming interface (API) or a command-line interface (CLI) of the analytics engine. The cohort of workloads 156 is a group of workloads 156 that are executed in a serial order 22 by the analytics engine. The workloads 156 may be any units of computation that can be expressed as, for example, directed acyclic graphs (DAGs) of tasks. The serial execution order 22 may be a predefined or user-defined order that specifies the sequence of execution of the workloads 156 in the cohort.

The method 400, at operation 404, includes, based on the serial execution order 22, executing, using the analytics engine and a default join configuration 202, a first portion of the workloads 156 in the cohort. The default join configuration 202 defines a first join operation to use during execution of the first portion of the workloads 156. The analytics engine may be any software framework or platform that enables large-scale data processing, data analysis, data mining, machine learning, or artificial intelligence on a distributed computing system. The analytics engine, in some examples, runs on a cluster of nodes that are interconnected by a network and that access data from one or more data sources. The analytics engine optionally includes a driver and one or more executors that coordinate and execute the workloads 156 on the cluster of nodes. The default join configuration 202 is a configuration that determines which join method to use for each join operation in a workload 156 or a cohort of workloads 156 (i.e., each workload 156 in the first portion). The first join operation may be any join method, such as sort merge join, shuffle hash join, broadcast hash join, Cartesian join, or broadcasted nested loop join. The first portion of the workloads 156 is a subset of the workloads 156 in the cohort that are executed before a second portion of the workloads 156 in the cohort, according to the serial execution order 22.

The method 400, at operation 406, includes determining, based on execution of the first portion of the workloads 156 in the cohort, an updated join configuration 220. The updated join configuration 220 may be a configuration that defines a second join operation to use during execution of the second portion of the workloads 156 in the cohort. The second join operation, in some implementations, is different from the first join operation defined by the default join configuration 202. The updated join configuration 220 may be determined based on execution of the first portion of the workloads 156 in the cohort using the default join configuration 202. In some examples, the execution of the first portion of the workloads 156 in the cohort is monitored and analyzed, and various runtime information and feedback nay be collected and evaluated, such as the size of the datasets, the data distribution, the data skewness, the data locality, the node availability, the node capacity, the node load, the network congestion, the join method, the join performance, the join cost, and the join result. Based on the runtime information and feedback, an updated join configuration 220 is determined that optimizes the execution of the second portion of the workloads 156 in the cohort.

The method 400, at operation 408, includes, based on the serial execution order 22, executing, using the analytics engine and the updated join configuration 220, a second portion of the workloads 156 in the cohort. The updated join configuration 220 defines a second join operation to use during execution of the second portion of the workloads 156. The second portion of the workloads 156 is a subset of the workloads 156 in the cohort that are executed after the first portion of the workloads 156 in the cohort based on the serial execution order 22. The second portion of the workloads 156 may be executed using the analytics engine and the updated join configuration 220. The execution of the second portion of the workloads 156, in some examples, includes providing, to the analytics engine, a query hint associated with the updated join configuration 220. The query hint is a directive or suggestion that instructs or influences the analytics engine to use a specific join method or parameter for executing the second portion of the workloads 156.

The method 400, at operation 410, includes returning, to the user, results of execution of the first portion and the second portion of the workloads 156 in the cohort. The results of execution may be any data or information that is generated or obtained by executing the workloads 156 in the cohort, such as intermediate or final results, statistics, metrics, reports, charts, graphs, or models. The results of execution, in some examples, are returned to the user or the application that submitted the request 20 to execute the cohort of workloads 156. For example, the results of execution are returned through an application programming interface (API) or a command-line interface (CLI) of the analytics engine.

The systems and methods herein may provide various advantages to conventional techniques, such as improving the performance, efficiency, and scalability of executing workloads 156 using an analytics engine in a distributed computing system. For example, the method 400 dynamically determines and updates join configurations based on runtime information and feedback to improve join performance. The method 400 may also determine and update executor memory configurations and/or executor amounts based on runtime information and feedback in order to optimize the resource utilization and allocation for executing workloads 156.

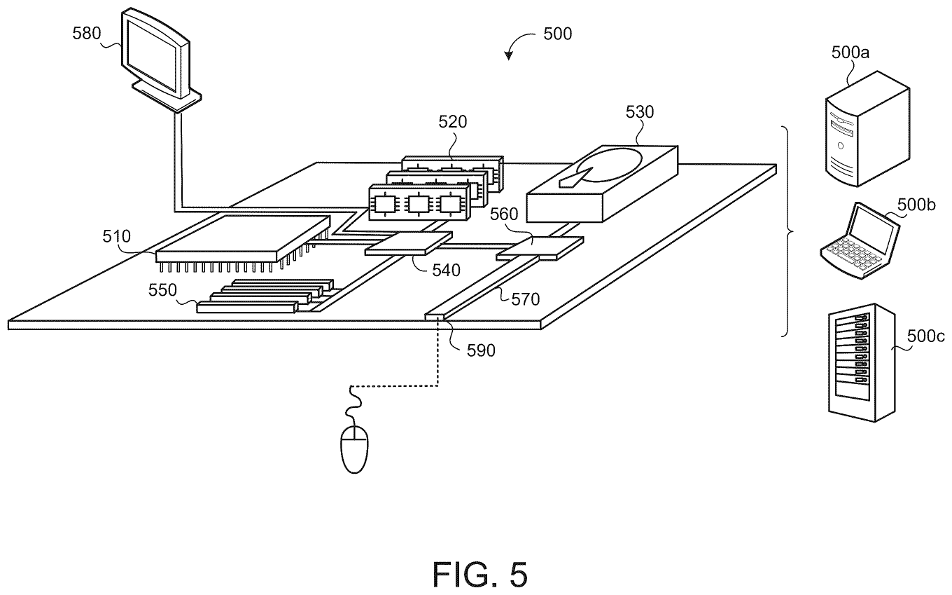

FIG. 5 is a schematic view of an example computing device 500 that may be used to implement the systems and methods described in this document. The computing device 500 is intended to represent various forms of digital computers, such as laptops, desktops, workstations, personal digital assistants, servers, blade servers, mainframes, and other appropriate computers. The components shown here, their connections and relationships, and their functions, are meant to be exemplary only, and are not meant to limit implementations of the inventions described and/or claimed in this document.

The computing device 500 includes a processor 510, memory 520, a storage device 530, a high-speed interface/controller 540 connecting to the memory 520 and high-speed expansion ports 550, and a low speed interface/controller 560 connecting to a low speed bus 570 and a storage device 530. Each of the components 510, 520, 530, 540, 550, and 560, are interconnected using various busses, and may be mounted on a common motherboard or in other manners as appropriate. The processor 510 can process instructions for execution within the computing device 500, including instructions stored in the memory 520 or on the storage device 530 to display graphical information for a graphical user interface (GUI) on an external input/output device, such as display 580 coupled to high speed interface 540. In other implementations, multiple processors and/or multiple buses may be used, as appropriate, along with multiple memories and types of memory. Also, multiple computing devices 500 may be connected, with each device providing portions of the necessary operations (e.g., as a server bank, a group of blade servers, or a multi-processor system).

The memory 520 stores information non-transitorily within the computing device 500. The memory 520 may be a computer-readable medium, a volatile memory unit(s), or non-volatile memory unit(s). The non-transitory memory 520 may be physical devices used to store programs (e.g., sequences of instructions) or data (e.g., program state information) on a temporary or permanent basis for use by the computing device 500. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

The storage device 530 is capable of providing mass storage for the computing device 500. In some implementations, the storage device 530 is a computer-readable medium. In various different implementations, the storage device 530 may be a floppy disk device, a hard disk device, an optical disk device, or a tape device, a flash memory or other similar solid state memory device, or an array of devices, including devices in a storage area network or other configurations. In additional implementations, a computer program product is tangibly embodied in an information carrier. The computer program product contains instructions that, when executed, perform one or more methods, such as those described above. The information carrier is a computer- or machine-readable medium, such as the memory 520, the storage device 530, or memory on processor 510.

The high speed controller 540 manages bandwidth-intensive operations for the computing device 500, while the low speed controller 560 manages lower bandwidth-intensive operations. Such allocation of duties is exemplary only. In some implementations, the high-speed controller 540 is coupled to the memory 520, the display 580 (e.g., through a graphics processor or accelerator), and to the high-speed expansion ports 550, which may accept various expansion cards (not shown). In some implementations, the low-speed controller 560 is coupled to the storage device 530 and a low-speed expansion port 590. The low-speed expansion port 590, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The computing device 500 may be implemented in a number of different forms, as shown in the figure. For example, it may be implemented as a standard server 500a or multiple times in a group of such servers 500a, as a laptop computer 500b, or as part of a rack server system 500c.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

A number of implementations have been described. Nevertheless, it will be understood that various modifications may be made without departing from the spirit and scope of the disclosure. Accordingly, other implementations are within the scope of the following claims.

What is claimed is:

1. A computer-implemented method executed by data processing hardware that causes the data processing hardware to perform operations comprising:
receiving, from a user, a request to execute a cohort of workloads by an analytics engine at a distributed computing system, the cohort defining a serial execution order for executing each of the workloads in the cohort;
based on the serial execution order, executing, using the analytics engine and a default join configuration, a first portion of the workloads in the cohort, the default join configuration defining a first join operation to use during execution of the first portion of the workloads;
determining, based on execution of the first portion of the workloads in the cohort, an updated join configuration;
based on the serial execution order, executing, using the analytics engine and the updated join configuration, a second portion of the workloads in the cohort, the updated join configuration defining a second join operation to use during execution of the second portion of the workloads, the second join operation different from the first join operation; and
returning, to the user, results of execution of the first portion and the second portion of the workloads in the cohort.

2. The method of claim 1, wherein the updated join configuration comprises a broadcast hash join.

3. The method of claim 1, wherein the default join configuration comprises one of:
a sort merge join;
a shuffle hash join;
a Cartesian join; or
a broadcasted nested loop join.

4. The method of claim 1, wherein executing, using the analytics engine and the updated join configuration, the second portion of the workloads in the cohort comprises providing, to the analytics engine, a query hint associated with the updated join configuration.

5. The method of claim 1, wherein determining the updated join configuration comprises determining one or more successful broadcasts of data in execution of the first portion of the workloads in the cohort.

6. The method of claim 1, wherein using the updated join configuration reduces an execution time of the second portion of the workloads in the cohort relative to using the default join configuration.

7. The method of claim 1, wherein:
the operations further comprise determining, based on execution of the first portion of the workloads in the cohort, an updated executor memory configuration; and
executing the second portion of the workloads in the cohort comprises using the updated executor memory configuration, the updated executor memory configuration defining an amount of memory available to execute the second portion of the workloads.

8. The method of claim 7, wherein the amount of memory defined by the updated executor memory configuration is greater than an amount of memory available when executing the first portion of the workloads.

9. The method of claim 7, wherein the amount of memory defined by the updated executor memory configuration is less than an amount of memory available when executing the first portion of the workloads.

10. The method of claim 1, wherein:
the operations further comprise determining, based on execution of the first portion of the workloads in the cohort, an updated initial number of executors and an updated maximum number of executors, and
executing the second portion of the workloads in the cohort comprises using the updated initial number of executors and the updated maximum number of executors, the updated initial number of executors defining a number of executors to use when beginning execution of the second portion of the workloads, the updated maximum number of executors defining a maximum number of executors to use when executing the second portion of the workloads.

11. A system comprising:
data processing hardware; and
memory hardware in communication with the data processing hardware, the memory hardware storing instructions that when executed on the data processing hardware cause the data processing hardware to perform operations comprising:
receiving, from a user, a request to execute a cohort of workloads by a analytics engine at a distributed computing system, the cohort defining a serial execution order for executing each of the workloads in the cohort;
based on the serial execution order, executing, using the analytics engine and a default join configuration, a first portion of the workloads in the cohort, the default join configuration defining a first join operation to use during execution of the first portion of the workloads;
determining, based on execution of the first portion of the workloads in the cohort, an updated join configuration;
based on the serial execution order, executing, using the analytics engine and the updated join configuration, a second portion of the workloads in the cohort, the updated join configuration defining a second join operation to use during execution of the second portion of the workloads, the second join operation different from the first join operation; and
returning, to the user, results of execution of the first portion and the second portion of the workloads in the cohort.

12. The system of claim 11, wherein the updated join configuration comprises a broadcast hash join.

13. The system of claim 11, wherein the default join configuration comprises one of:
a sort merge join;
a shuffle hash join;
a Cartesian join; or
a broadcasted nested loop join.

14. The system of claim 11, wherein executing, using the analytics engine and the updated join configuration, the second portion of the workloads in the cohort comprises providing, to the analytics engine, a query hint associated with the updated join configuration.

15. The system of claim 11, wherein determining the updated join configuration comprises determining one or more successful broadcasts of data in execution of the first portion of the workloads in the cohort.

16. The system of claim 11, wherein using the updated join configuration reduces an execution time of the second portion of the workloads in the cohort relative to using the default join configuration.

17. The system of claim 11, wherein:
the operations further comprise determining, based on execution of the first portion of the workloads in the cohort, an updated executor memory configuration; and
executing the second portion of the workloads in the cohort comprises using the updated executor memory configuration, the updated executor memory configuration defining an amount of memory available to execute the second portion of the workloads.

18. The system of claim 17, wherein the amount of memory defined by the updated executor memory configuration is greater than an amount of memory available when executing the first portion of the workloads.

19. The system of claim 17, wherein the amount of memory defined by the updated executor memory configuration is less than an amount of memory available when executing the first portion of the workloads.

20. The system of claim 11, wherein:
the operations further comprise determining, based on execution of the first portion of the workloads in the cohort, an updated initial number of executors and an updated maximum number of executors; and
executing the second portion of the workloads in the cohort comprises using the updated initial number of executors and the updated maximum number of executors, the updated initial number of executors defining a number of executors to use when beginning execution of the second portion of the workloads, the updated maximum number of executors defining a maximum number of executors to use when executing the second portion of the workloads.
